(19) United States
(12) Patent Application Publication
(10) Pub. No.: US 2012/0000195 A1
(43) Pub. Date: Jan. 5, 2012

(54) Tube Actuator

(76) Inventor: Scott Semenik, St. Charles, IL (US)

(21) Appl. No.: 13/255,606

(22) PCT Filed: Mar. 9, 2010
(86) PCT No.: PCT/US10/26641

§ 371 Date: Sep. 9, 2011

Related U.S. Application Data
(60) Provisional application No. 61/158,481, filed on Mar. 9, 2009.

(51) Int. Cl. F03G 7/06

(52) U.S. Cl. 60/527

(57) ABSTRACT

This invention relates to an actuator (2) comprising material adapted to contract when activated (4) within an inner sleeve assembly (24) contained by an outer sleeve assembly (22) that is cylindrical in shape. The inner sleeve (24) assembly further comprises a slide (16), an overstress spring (14), a sleeve (8), and a rebias spring (12). When the material adapted to contract (4) is activated, the contraction causes a rebias spring (12) to compress and a working end piece (18) moves causing desired movement. When the rebias (spring 12) expands, the actuator (2) returns to its normal resting position. In some embodiments a magnetic latch (44) can be paired with and activated by the actuator (2).

### FIELD OF THE INVENTION

This invention relates to a tube actuator. More specifically, this invention relates to tube actuator using smart memory alloy (SMA) wire.

### BACKGROUND OF THE INVENTION

Actuators are widely known in prior art and are widely used for a variety of commercial purposes. However, many actuators require large amounts of space to move to adequately handle its load. Tube actuators are ideal for moving within a small space. This invention uses material adapted to contract when activated to created movement within a small space.

### SUMMARY OF THE INVENTION

This invention relates to an actuator comprising material adapted to contract when activated within an inner sleeve assembly contained by an outer sleeve assembly that is cylindrical in shape. The inner sleeve assembly further comprises a slide, an overstress spring, a sleeve, and a rebias spring.

The material adapted to contract when activated is preferably shape memory alloy wire and has crimped lead attached. Shape memory alloys are known and are usually made predominantly or wholly of titanium and nickel. They may also include other material, such as aluminium, zinc and copper. A shape memory alloy is capable of adopting one shape below a predetermined transition temperature and changing to a second shape once its temperature exceeds the transition temperature. Conversely, when the shape memory alloy cools below the transition temperature, it is capable of adopting the first shape again. In connection with the various aspects of the present invention, the shape memory alloy contracts when heated in situ. Shape memory alloy wire currently available, such as that sold under the trade mark Nitinol, is capable of contracting by about 3% when activated by heating.

Activation of the material adapted to contract when activated is preferably achieved through electrical resistance heating, with a wire feed to the assembly. Activation of the shape memory alloy wire can be initiated from a central location, using the wiring system of, for example, the home the lockset is located in. It is also within the scope of this invention that the activation is initiated by remote means, such as a hand held tool operating through the use of any suitable form of energy, including microwave, electric magnetic, sonic, infra-red, radio frequency and so on.

The scope of the invention in its various aspects is not necessarily limited to the use of shape memory alloy. Other material may also be useful. Also, while activation may take place through heating, other means of activation may be suitable and are within the scope of this invention.

The material adapted to contract runs through the inner sleeve assembly. Both ends of the material adapted to contract when activated are crimped and joined with wire leads for connection to an energy (activating) source. The slide is aligned with an overstress spring and connected to a sleeve by a spacer. On the other end of the sleeve is another spacer and a rebias spring. On the end with the rebias spring is a shuttle that houses the working end piece. This entire inner sleeve assembly is housed by the outer sleeve assembly.

When the material adapted to contract is activated, the wire contraction causes the rebias spring to compress and the working end piece moves causing desired movement. When the rebias spring expands, the actuator returns to its normal resting position.

Overstress of the material adapted to contract when activated is a concern so the overstress spring serves to prevent wire stress and possible breakage. If the working end piece jams or is somehow restricted, the overstress spring will move to protect the material adapted to contract when activated.

Another embodiment of this tube actuator is to pair it with a magnetic latch that is activated by the tube actuator. The aspects of the tube actuator are the same as described above. However, once the tube actuator is activated the working end piece displaces magnets causing them to be in the repelled position and allowing a latch to be unhinged. There are many benefits to pairing a tube actuator with a magnetic latch such as it can be activated with a remote switch, there is smooth operation (attracts and repels), an easy mechanical override can be incorporated, and the SMA could be removed and replaced with a mechanical switch if a design called for that replacement.

Other advantages and aspects of the present invention will become apparent upon reading the following description of the drawings and the detailed description of a preferred embodiment of the invention.

### BRIEF DESCRIPTION OF THE DRAWINGS

FIG. 1 is an exploded view of the tube actuator.

FIG. 2 is a sectional view of the tube actuator.

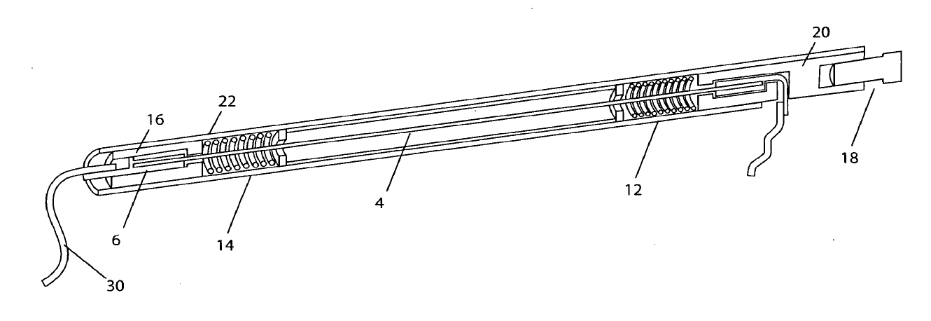

FIG. 3 is a view of the magnets joined with the tube actuator.

FIG. 4 is a view of the magnets joined with the tube actuator which is linked to a PCB.

FIG. 5 is an exploded view of the magnetic latch element.

FIG. 6 is a sectional view of the magnets within a device.

### DETAILED DESCRIPTION OF THE PREFERRED EMBODIMENT

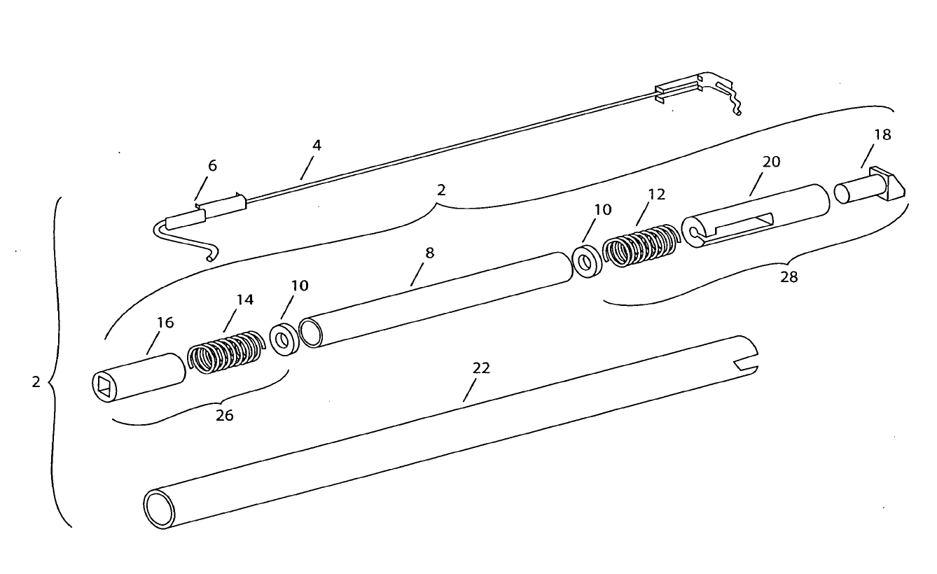

FIG. 1 depicts an exploded view of the parts comprising the tube actuator 2. The outer sleeve assembly 22 houses the inner sleeve assembly 24. The inner sleeve assembly comprises a sleeve 8 which has a working end 28 on one side and a non-working end 26 on the other. The non-working end comprises a slide 16, an overstress spring 14 and a spacer 8. The working end 28 comprises a spacer 10, a rebias spring 12, and a shuttle 20. A working end piece 18 is housed partially within the shuttle 20. The material adapted to contract when activated 4 runs through the inner sleeve assembly and is crimped 6 on both ends. A wire lead 30 is joined on each of the crimps 6.

When the material adapted to contract 4 is activated, the contraction causes the rebias spring 12 to compress and the working end piece 18 moves causing desired movement. When the rebias spring 12 expands, the tube actuator 2 returns to its normal resting position. If the working end piece 18 jams or is somehow restricted, the overstress spring 14 will move to protect the material adapted to contract 4 when activated.

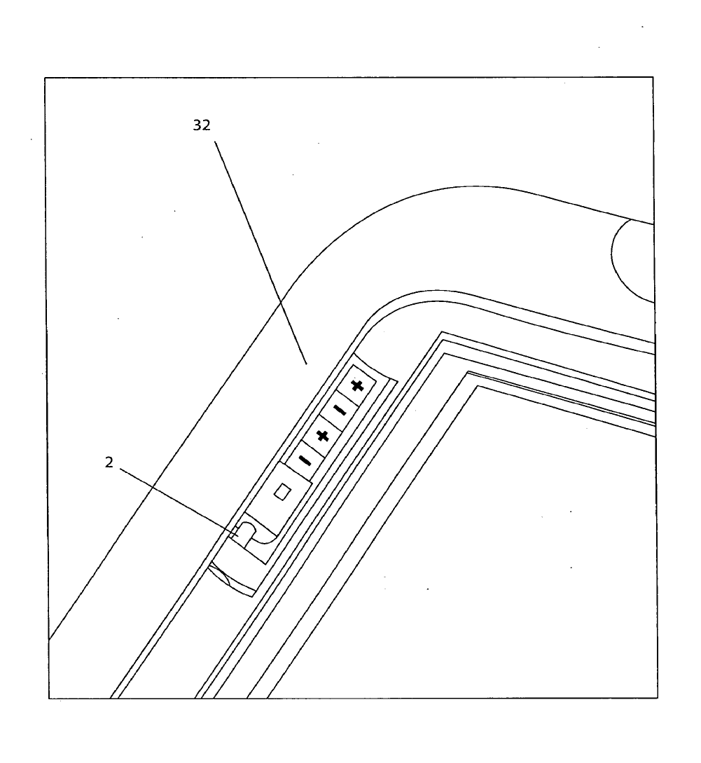

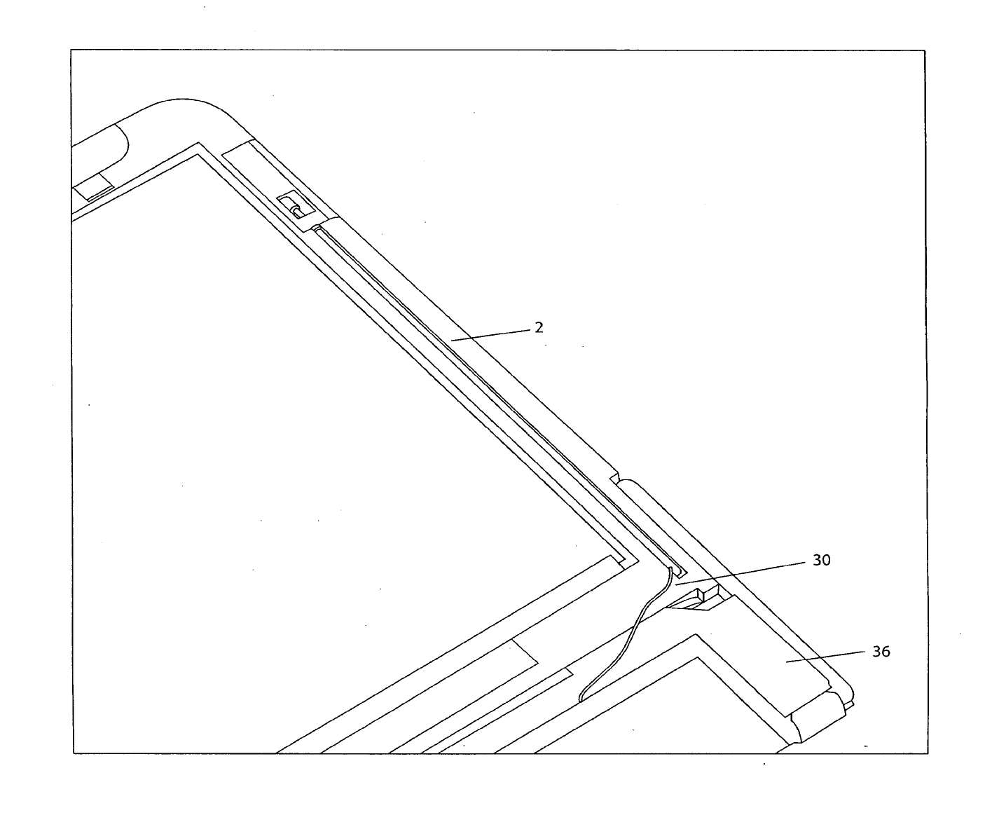

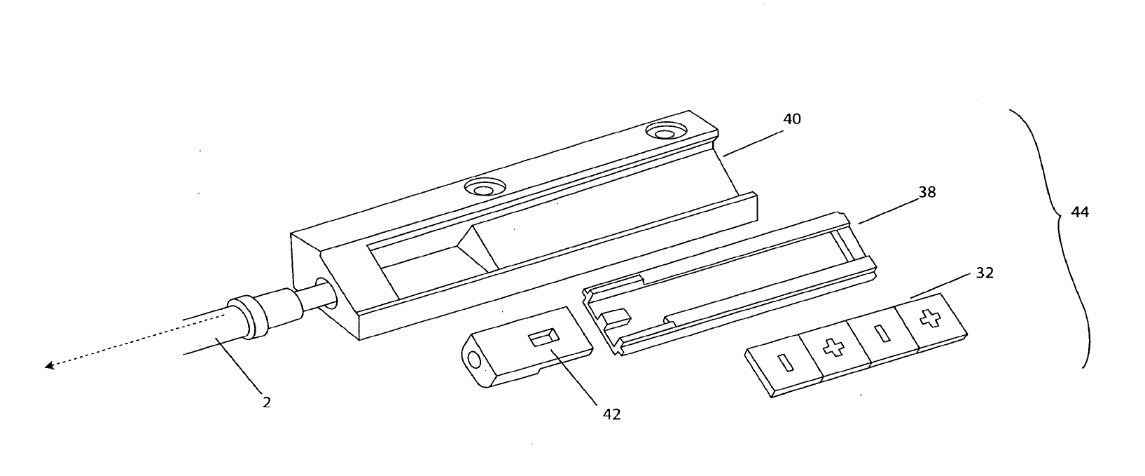

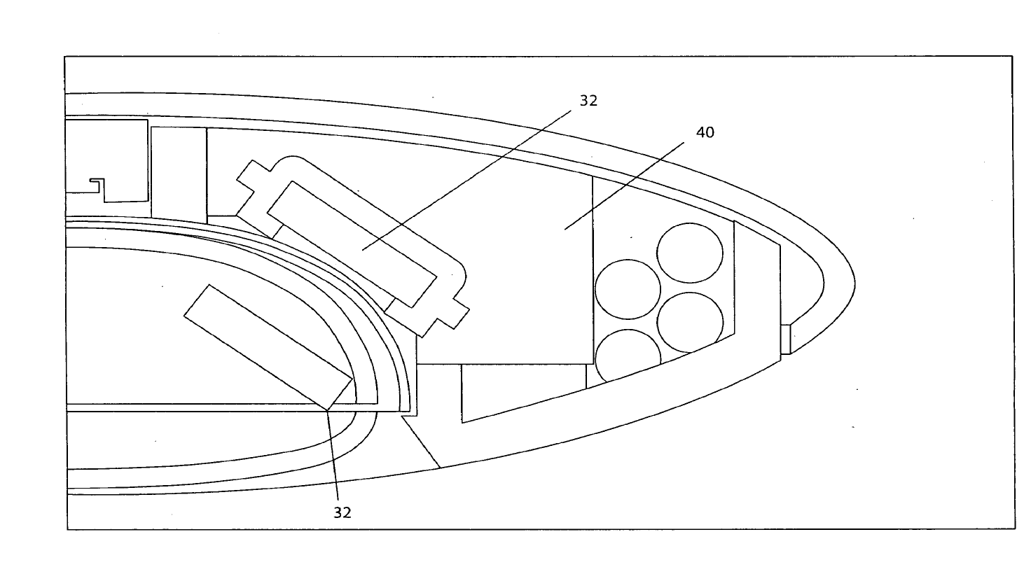

FIGS. 3-6 depicts this tube actuator 2 paired it with a magnetic latch element 44 that is activated by the tube actuator 2. The aspects of the tube actuator 2 are the same as described earlier. The magnetic latch element further comprises a slide retention block 40, a magnetic slide 38, magnets 32, and a connector block 42. The magnetic slide 38 houses the magnets 32 and both pieces 32, 38 are then housed in the slide retention block 40. The connector block 42 joins the magnetic latch element 44 to the tube actuator 2. Upon activation of the tube actuator 2, the slide retention block 40 moves and the magnets 32 are repelled allowing the magnetic latch element 40 to be unlocked. The magnets 32 then attract each other sliding the magnetic latch element back into is locked position.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

### INDUSTRIAL APPLICABILITY

As will be readily appreciated by those skilled in the various arts, the invention disclosed herein is not limited to the examples set out and has wide application in many areas. The invention represents a significant advance in the art of actuators.

What is claimed is:

1. A tube actuator comprising material adapted to contract when activated within an inner sleeve assembly contained in an outer sleeve assembly.

2. The tube actuator of claim 1 wherein said inner sleeve assembly further comprises a slide, an overstress spring, a sleeve, and a rebias spring.

3. The tube actuator of claim 1 wherein said outer sleeve assembly is cylindrical in shape and further comprises a working end.

4. The tube actuator of claim 2 where said material adapted to contract when activated is activated causing said rebias spring to compress and moving the working end.

5. A tube actuator for locking/unlocking a magnetic device comprising:
material adapted to contract when activated within an inner sleeve assembly contained in an outer sleeve assembly and
a slide retention block further comprising a magnetic holder, magnets, and a connector block.

6. The tube actuator of claim 5 wherein said inner sleeve assembly further comprises a slide, an overstress spring, a sleeve, and a rebias spring.

7. The tube actuator of claim 5 wherein said outer sleeve assembly is cylindrical in shape and further comprises a working end.

8. The tube actuator of claim 6 where said material adapted to contract when activated is activated causing said rebias spring to compress and moving the working end so that the magnets are pulled to a repelled position and the tube actuator is in the unlocked position.

9. The tube actuator of claim 8 whereby said magnets return to the attracted rested position.
